(19) United States
(12) Patent Application Publication
(10) Pub. No.: US 2006/0093056 A1
(43) Pub. Date: May 4, 2006

(54) Signal reception in mobile communication network

(76) Inventors: Pekka Kaasila, Oulu (FI); Marko Lampinen, Oulu (FI); Jorma Kaikkonen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/125,408

(22) Filed: May 10, 2005

Related U.S. Application Data
(60) Provisional application No. 60/622,795, filed on Oct. 29, 2004.

(51) Int. Cl. H04L 1/02; H04B 1/10; H04B 1/707

(52) U.S. Cl. 375/267; 375/350; 375/141

(57) ABSTRACT

A receiver in a mobile communication network, including a receiving unit to receive signals transmitted in at least two channels, a channel estimator to form a channel estimate for each transmit channel, at least two linear filters, wherein each linear filter is configured to filter a signal received on a channel, each filter having a filter coefficient defining the filtering, a calculating unit to form at least one combining weight by convolving a channel estimate and a filter coefficient, a combiner, which is configured to form at least two filter-specific weighted signals by weighting a filtered signal with at least one combining weight; and the combiner is configured to combine at least two filter-specific weighted signals to provide an estimate for the transmitted signal.

### CROSS-REFERENCE TO RELATED APPLICATION

This nonprovisional application claims the benefit of U.S. provisional Application No. 60/622,795, filed on Oct. 29, 2004. The disclosure of the prior application is hereby incorporated by reference herein in its entirety.

### FIELD

The invention relates to receiving of a signal in a mobile communication network, especially to reception of a signal in a network applying transmit diversity.

### BACKGROUND

Third generation mobile systems aim to provide users with a plurality of applications, including visual services and effective use of the Internet, for instance. New ways of communication pose new requirements on network capacity and quality of service.

One technology for the third generation networks is a Wideband Code Division Multiple Access (WCDMA). High speed downlink packet access (HSDPA) is a WCDMA key feature providing high rate data transmission on CDMA downlink to support multimedia services.

For WCDMA, one way to improve quality by diminishing detrimental effects of fading in a received signal is transmit diversity. At least two instances of the signal, modified to each other, are transmitted via at least two channels. Two principal ways for implementing transmit diversity have been introduced, which are a closed loop transmit diversity mode and a STTD (space-time block coding based transmit antenna diversity) mode. In the closed loop transmit diversity mode, a spread complex value signal is fed to different antenna branches and weighted with antenna-specific weight factors. The weight factors, typically complex value signals, are determined by a receiver (terminal) and signaled to the network. In STTD encoding, symbols can be conveyed to different transmission antennas in different order and/or complex-conjugated, for instance.

FIG. 1 shows a principal structure of a transmitter and a receiver employing STTD. In FIG. 1, space-time block coding is applied in a transmitter 100 in order to provide transmit diversity to the signal. A signal d incoming to a space-time block coding unit 102 includes two symbols, d₁ and d₂. As an output from the space-time block coding unit, two differently modified signal instances are obtained by using symbols d₁ and d₂. In the first instance |d₁d₂|, symbol d₁ is transmitted before d₂. In the second instance |−d₂*d₁*|, a minus-signed complex-conjugate of d₂ is transmitted before complex-conjugated d₁.

The formed signals are spread by using the user's spreading code in a spreading unit 104. The spread signals are conveyed to transmit antennas, whereby transmit channels 106A and 106B are established. A combiner 108 highlights the combining that occurs on a radio path.

A receiver 120 receives the signal in two linear filters 124A and 124B, wherein the first filter 124A receives channel 1 and the second filter 124B receives channel 2. As an output, the first linear filter produces desired signal r₁ according to (1)

$${r}_{1} = [ \begin{matrix}{r}_{1 , 1} \\ {r}_{1 , 2}^{*}\end{matrix} ] , \qquad ( 1 )$$

wherein
r_{1,1} is symbol 1 received via channel 1, and
r_{1,2}* is complex conjugate of symbol 2 received via channel 1.

Correspondingly, as an output, the second receiver branch produces signal r₂ according to (2).

$${r}_{2} = [ \begin{matrix}{r}_{2 , 1} \\ {r}_{2 , 2}^{*}\end{matrix} ] , \qquad ( 2 )$$

r_{2,1} is symbol 1 received via channel 2, and
r_{2,2}* is complex conjugate of symbol 2 received via channel 2.

In a receiver, besides trying to receive a particular antenna (channel) as optimally as possible, each equalizer also tries to suppress the interference of the other antennas at the output of the equalizer. The outputs of the equalizers are combined in a combiner including STTD decoders 140A, 140B and an adder 142, to provide an estimate of the transmitted signal.

Conventionally, STTD combining is carried out according to rule (3)

$${\hat{d}}_{1} \hat{=} [ \begin{matrix}{\hat{d}}_{1 , 1} \\ {\hat{d}}_{1 , 2}^{*}\end{matrix} ] = [ \begin{matrix}1 & 0 \\ 0 & 1\end{matrix} ] \cdot {r}_{1} \\ {\hat{d}}_{2} \hat{=} [ \begin{matrix}{\hat{d}}_{2 , 1} \\ {\hat{d}}_{2 , 2}^{*}\end{matrix} ] = [ \begin{matrix}0 & 1 \\ - 1 & 0\end{matrix} ] \cdot {r}_{2} \\ \hat{d} \hat{=} [ \begin{matrix}{\hat{d}}_{1} \\ {\hat{d}}_{2}^{*}\end{matrix} ] = {\hat{d}}_{1} + {\hat{d}}_{2} \qquad ( 3 )$$

, wherein
\hat{d}ᵢ is an estimate for the signal received in filter i,
\hat{d}_{j,n} is an estimate of the transmitted signal from filter j at time instant n.
\hat{d} is an estimate for the transmitted signal and
* denotes a complex conjugate.

The outputs of the STTD decoders 140A and 140B are combined in adder 142 so as to create an estimate for the transmitted signal d. Prior art combining counts on mutual cancellation of interfering signals; however, more effective ways are available.

### SUMMARY

It is thus an object of the present invention to provide an improved method and a receiver for receiving a signal in a mobile communication network.

In one aspect of the invention, there is provided a receiver in a mobile communication network, including a receiving unit to receive signals transmitted in at least two channels, a channel estimator to form a channel estimate for each transmit channel, at least two linear filters, wherein each linear filter is configured to filter a signal received on a channel, each filter having a filter coefficient defining the filtering, a calculating unit to form at least one combining weight by convolving a channel estimate and a filter coefficient, a combiner, which is configured to form at least two filter- specific weighted signals by weighting a filtered signal with at least one combining weight and

the combiner is configured to combine at least two filter-specific weighted signals to provide an estimate for the transmitted signal.

In another aspect of the invention, there is provided a receiver in a mobile communication network, including means for receiving signals transmitted in at least two channels, means for forming a channel estimate for each transmit channel, means for filtering the received signals in channel-specific linear filters to provide an estimate for a desired signal in each channel, means for forming at least one combining weight by convolving a channel estimate and a filter coefficient, means for forming a filter-specific weighted signal by weighting the received signal with the formed at least one combining weight, means for combining the filter-specific weighted signals to provide an estimate for the transmitted signal.

In another aspect of the invention, there is provided a subassembly for a mobile terminal, including a calculating unit to form at least one combining weight by convolving a channel estimate and a filter coefficient, a combiner, which is configured to form at least two filter-specific weighted signals by weighting a filtered signal with at least one combining weight; and combine the at least two filter-specific weighted signals.

In another aspect of the invention, there is provided a mobile communication system, including a transmitter and a receiver, wherein the transmitter a configured to apply transmit diversity so as to provide at least two transmit channels, and the receiver is configured to receive signals transmitted in the at least two channels, form a channel estimate for each transmit channel, filter the received signals in channel-specific linear filters to provide an estimate for a desired signal in each channel, form at least one combining weight by convolving a channel estimate and a filter coefficient, form a filter-specific weighted signal by weighting the received signal with the formed at least one combining weight, combine the filter-specific weighted signals to provide an estimate for the transmitted signal.

In another aspect of the invention, there is provided a software product, including software code portions for implementing the steps of receiving signal transmitted in at least two transmit channels by applying transmit diversity, forming a channel estimate for each transmit channel, filtering the received signals in channel-specific linear filters to provide an estimate for a desired signal in each channel, forming at least one combining weight by convolving a channel estimate and a filter coefficient, forming a filter-specific weighted signal by weighting the filtered signal with the formed at least one combining weight; and combining the filter-specific weighted signals to provide an estimate for the transmitted signal.

In another aspect of the invention, there is provided a method for processing a signal in a mobile communication network, including transmitting the signal via at least two transmit channels, receiving the signals transmitted in the at least two transmit channels, forming a channel estimate for each transmit channel, filtering the received signals in channel-specific linear filters to provide an estimate for a desired signal in each channel, forming at least one combining weight by convolving a channel estimate and a filter coefficient;

forming a filter-specific weighted signal by weighting the filtered signal with the formed at least one combining weight; and combining the filter-specific weighted signals to provide an estimate for the transmitted signal.

The invention thus relates to receiving of a signal in a mobile communication network. The mobile network according to the invention can be a Universal Mobile Telephony System (UMTS) employing Wideband Code Division Multiple Access (WCDMA) radio technology, for instance. The invention can be applied in a network employing High Speed Downlink Packet Access (HSDPA), for instance.

In the invention, a connection is established between a transmitter and a receiver. In one embodiment, the transmitter is a base station of a mobile network, or with reference to UMTS, Node B. In such a case, the receiver can be a mobile terminal that is connection with the network. In another aspect of the invention, the transmitter is a mobile terminal and the receiver is a base station/Node B. The mobile terminal can be a mobile phone or a laptop computer, for instance.

In the invention, the transmitter provides a connection by applying transmit diversity, which can be provided by space-time block coding or by closed-loop weighting, for instance. Signals can be transmitted via different transmit antennas so as to provide at least two transmit channels. A logical channel to be processed according to the invention can be any channel.

The transmit channels are received separately in a receiver so that there is a receiver branch for each channel. In the receiver, the received channels are estimated so as to provide a channel impulse response including one or more channel coefficients. The channel coefficients show the receiving amplitude, phase and delay of different multipath components on the received channel. Each channel is filtered in a linear filter, which can be a rake receiver or an equalizer, for instance. The filtering of each linear filter is characterized by a filter-specific filter coefficient.

The filtered signal is further manipulated in the receiver so as to collect all the desired signal components. The manipulation is based on forming one or more combination weights, each being a convolution of a channel and a filter. Thereby, the output of a first filter filtering a first channel can be corrected by reducing by signal components present in a signal received in a second channel.

The separately processed channel signals are finally combined to provide an estimate for the transmitted signal.

The method and apparatus according to the invention enable the quality of a received signal to be improved.

### DRAWINGS

In the following, the invention will be described in greater detail by means of preferred embodiments with reference to the attached drawings, in which

FIG. 1 shows already disclosed prior art processing of a signal

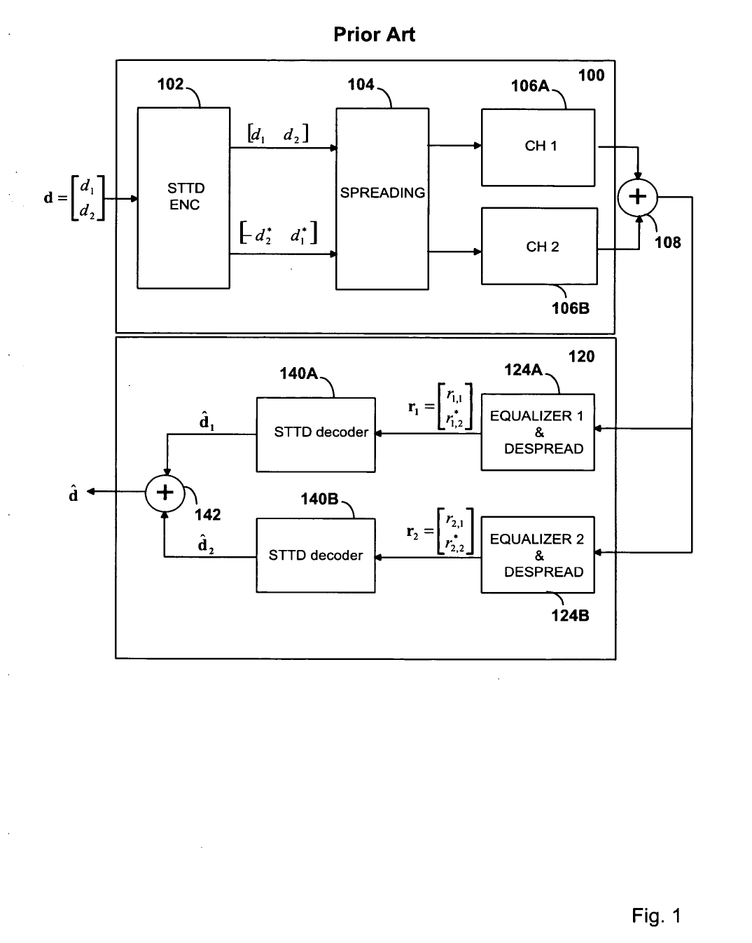

FIG. 2 shows one embodiment of a network according to the invention;

FIG. 3 shows another embodiment of an arrangement according to the invention;

FIG. 4 shows still another embodiment of an arrangement according to the invention;

FIG. 5 shows one embodiment of a method according to the invention.

### DISCLOSURE OF SOME EMBODIMENTS

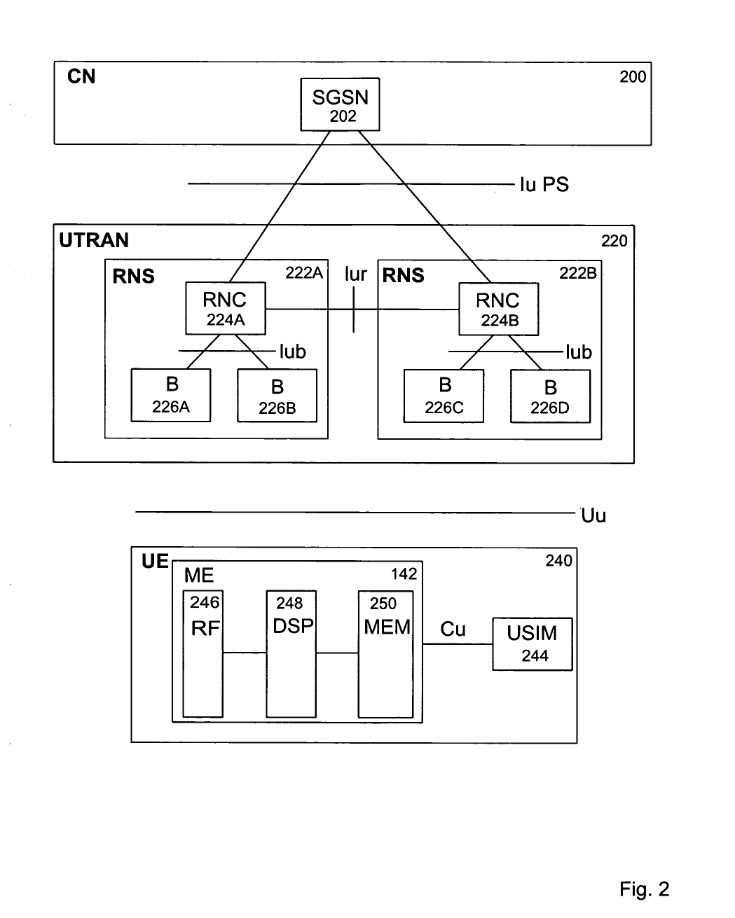

In one embodiment of the invention, the network is a UMTS network applying WCDMA technology. In the following, the structure of the UMTS network is shortly discussed with reference to FIG. 2.

Structurally, the WCDMA can be divided into a core network (CN) 100, a UMTS terrestrial radio access network (UTRAN) 220, and user equipment (UE) 240. The core network and the UTRAN are part of a network infrastructure of the wireless telecommunications system.

The core network includes a serving GPRS support node (SGSN) 202 connected to the UTRAN over an lu PS interface. The SGSN represents the center point of the packet-switched domain of the core network, and the main task of the SGSN is to transmit/receive packets to/from user equipment using the UTRAN. The SGSN may contain subscriber and location information related to the user equipment.

The UTRAN may include at least one radio network sub-system (RNS) 222A, 222B, each of which includes at least one radio network controller (RNC) 224A, 224B and at least one Node B 226A to 226D controlled by the RNC. Node B implements a Uu radio interface, through which the user equipment may access the network infrastructure.

The user equipment or the mobile terminal may include two parts, which are mobile equipment (ME) 242 and a UMTS subscriber identity module (USIM) 244. The mobile equipment includes radio frequency parts 246 for providing the Uu-interface. The user equipment may further include a digital signal processor 248, memory 250, and computer programs for executing computer processes. The user equipment may further include an antenna, a user interface, and a battery. The USIM comprises user-related information and information related to information security, such as an encryption algorithm.

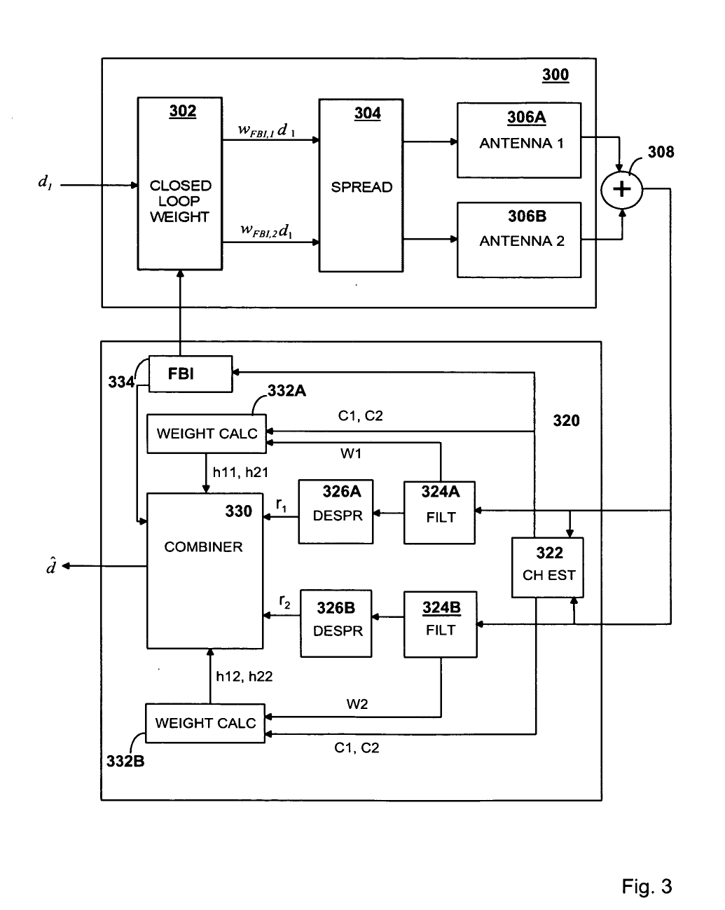

FIG. 3 shows one example of an arrangement according to the invention. In a transmitter, symbol d₁ to be transmitted is weighted in a weighting module 302 with antenna-specific weighting factors w_{FBI,1} and w_{FBI,2}. The weighting factors can be complex value signals w_{FBI,i}=aᵢ+jbᵢ, for instance. As an output, two differently weighted symbols w_{FBI,1}d₁ and w_{FBI,2}d₁ are obtained for a spreading unit 304. Although FIG. 3 shows weighting of the signal before spreading, weighting can also be carried out after spreading.

The weighting factors can be determined and signalled to the network by a receiver. In the case of HSDPA, the weighting factors can be transmitted to the network using a D-sub-field of an FBI (Feedback Information) field on an uplink DPCCH (Dedicated Physical Control Channel) channel.

A closed loop mode can apply either the same or different CPICH (Common Pilot Channel) pilot symbols on both channels. The receiver can use the pilot symbols in order to separate between the channels.

In weight calculation, one weight can be kept constant while another weight can be determined on the basis of received phases of consecutive slots.

In a receiver 320, channels are separately processed in processing units 324A and 324B, 326A, 326B, and the different channels are combined in a combiner 330 so as to provide an estimate for the transmitted signal.

The combiner is also configured to utilize the signal received on channel 2 when making an estimate for the signal received on channel 1, and vice versa. In one embodiment, the estimate for the transmitted signal is formed in the combiner 330 as follows:

$$\hat{d} \hat{=} [ {\hat{w}}_{FBI , 1}^{*} {h}_{1 , 1}^{*} + {\hat{w}}_{FBI , 2}^{*} {h}_{2 , 1}^{*} {\hat{w}}_{FBI , 1}^{*} {h}_{1 , 2}^{*} + {\hat{w}}_{FBI , 2}^{*} {h}_{2 , 2}^{*} ] [ \begin{matrix}{r}_{1} \\ {r}_{2}\end{matrix} ] , \qquad ( 4 )$$

wherein

h_{i,j} denotes a convolution between channel i (channel coefficients c1 and c2) and filter j (filter coefficients w1 and w2) and ŵ_{FBI,i} is the estimate or assumed complex antenna weight w_{FBI,i} used in channel i. The antenna weights used in transmitter can be estimated in feedback information providing unit 334 and the estimated weights can be transmitted to the combiner 330 to be used in combining as shown by (4). Alternatively, the receiver can assume that the weights it has transmitted to the transmitter have been used by the transmitter and the weights can be conveyed to the combiner 330 to be used in combining as shown by (4).

Instead of having two calculating units 332A and 332B, calculating of weights can be done in a single unit as well.

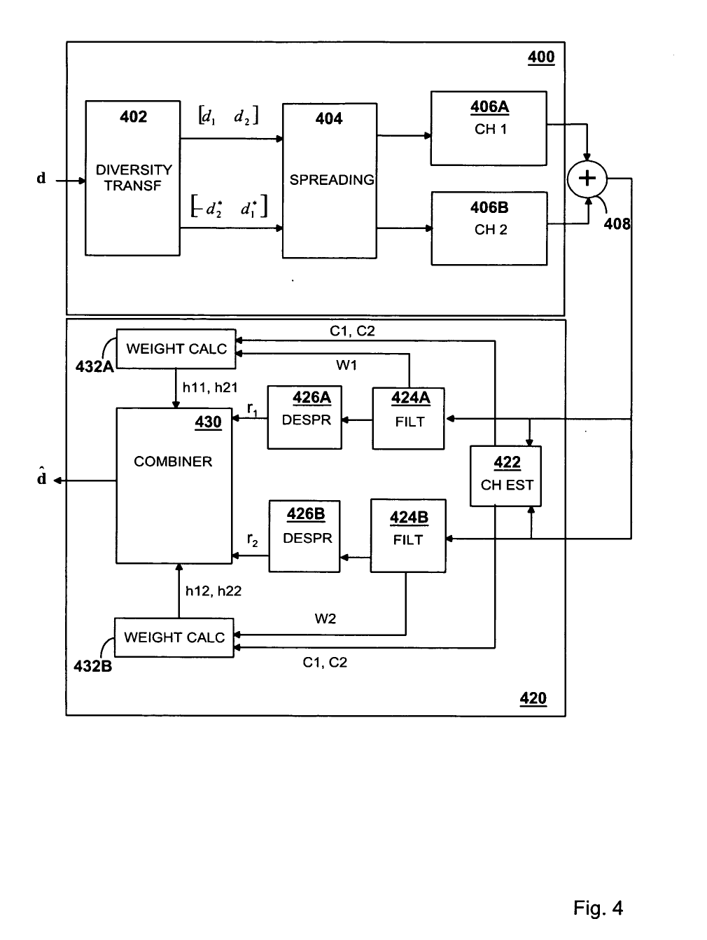

FIG. 4 illustrates still another embodiment of a transmitter and a receiver. The transmitter 400 includes a diversity transformation unit 402. Transmit diversity can be achieved by space-time block coding, for instance. The two signals are spread into a wideband signal in a spreading unit 404. The transmitter further includes two transmit antennas 406A and 406B for transmitting two transmit channels from the transmitter 400. The two channels merge on the radio path, as illustrated by a combining symbol 408.

The two channels are received in a receiver 420 so that there is a separate receiving branch for each channel. The receiver may include a channel estimating unit for estimating the channels. The channel estimating unit 422 may form a channel impulse response from a received channel. The channel impulse response is characterized by channel coefficients, which show the delay, amplitude and phase of different multipath components on the channel.

The received and estimated signal is filtered in linear filters 424A and 424B. Linear filters according to the invention can be rake receivers or equalizers, for instance. The linear filters 424A and 424B are characterized by filtering coefficients W1 and W2, respectively. The filtered signals can be despread in despreading units 426A and 426B.

A combiner 430 combines the filter-specific signals. For the combining, the combiner can take input values from weight calculating units 432A and 432B. The weight calculating unit 432A, for instance, can provide coefficient h_{1,1}, which is a convolution between channel 1 and filter 1. Coefficient h_{2,1} shows a convolution between channel coefficient c₂ and filter coefficient w₁. Thus, the weight calculating unit 432A provides coefficients that are necessary for adjusting the signal received on channel 1. The weight calculation unit 432B respectively provides the combiner with coefficients necessary for modifying the signal received on channel 2. Functionality performed in the combiner and in the calculating units is highlighted by formula (5).

$${\hat{d}}_{1} \hat{=} [ \begin{matrix}{\hat{d}}_{1 , 1} \\ {\hat{d}}_{1 , 2}^{*}\end{matrix} ] = [ \begin{matrix}{h}_{1 , 1}^{*} & {h}_{2 , 1} \\ - {h}_{2.1}^{*} & {h}_{1 , 1}\end{matrix} ] \cdot {r}_{1} \\ {\hat{d}}_{2} \hat{=} [ \begin{matrix}{\hat{d}}_{2 , 1} \\ {\hat{d}}_{2 , 2}^{*}\end{matrix} ] = [ \begin{matrix}{h}_{1 , 2}^{*} & {h}_{2 , 2} \\ - {h}_{22}^{*} & {h}_{1 , 2}\end{matrix} ] \cdot {r}_{2} \\ \hat{d} \hat{=} [ \begin{matrix}{\hat{d}}_{1} \\ {\hat{d}}_{2}^{*}\end{matrix} ] = {\hat{d}}_{1} + {\hat{d}}_{2} \qquad ( 5 )$$

wherein h_{i,j} denotes convolution between channel i (channel coefficient) and filter j (filter coefficient), and

\hat{d}ᵢ is an estimate of the transmitted signal from filter j, and

\hat{d}_{j,n} is an estimate of the transmitted signal from filter j at time instant n.

An advantage provided by the combiner according to the invention is that an undesired signal can also effectively be reduced from a channel signal. In the case of signal received on channel 1, the undesired signal is the signal received on channel 2 but present in filter 1.

As an output of the combiner, an estimate of the original signal d is obtained.

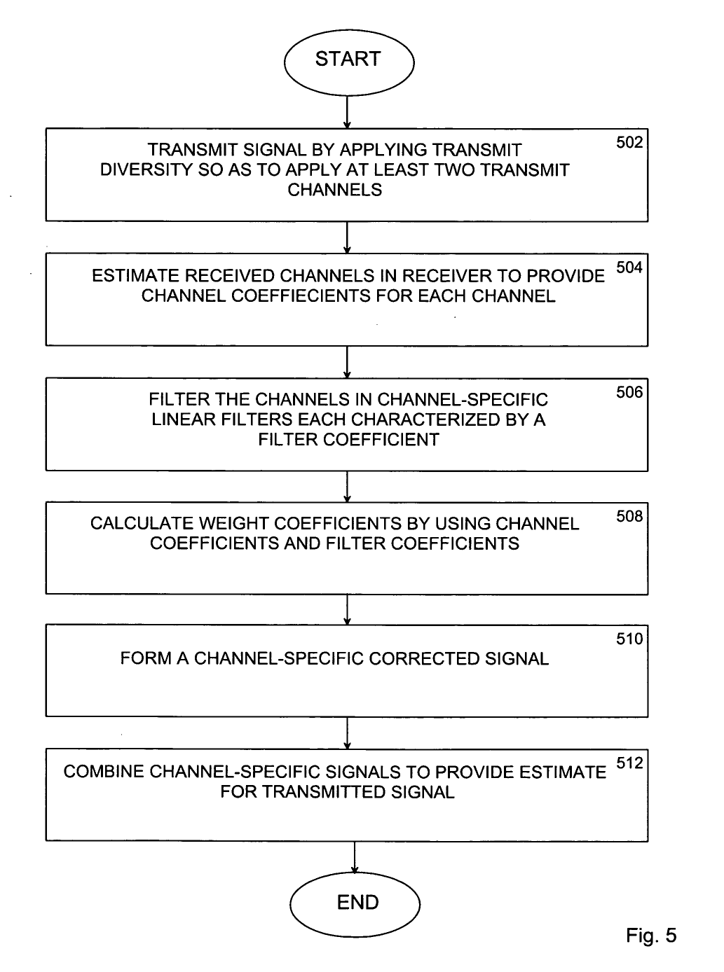

FIG. 5 shows one embodiment of a method according to the invention. In 502, a signal is transmitted from a transmitter, such as a base station or Node B, by applying transmit diversity. The transmit diversity may be provided by transmitting the signal via two separate transmit antennas, whereby two transmit channels are established.

In 504, the channels are estimated in the receiver and, in 506, the signals received on the channels are filtered by a linear filter. In 508, weight coefficients can be formed by convolving each channel with each filter. Thus, in the case of two channels and two filters, four weight coefficients are calculated. In 510, channel-specific signals are formed and then combined in 512 to provide an estimate for the transmitted signal.

In an embodiment of the invention, there is provided a software product, downloadable to a computer, and when executed, being configured to implement method steps of the invention. Thus, in one embodiment, there is provided a software product for providing the functionality defined by the method of the invention. The features of the invention can be implement by software, ASIC (Application Specific Integrated Circuit), Logic Components or in some corresponding manner.

It will be obvious to a person skilled in the art that as technology advances, the inventive concept can be implemented in various ways. The invention and its embodiments are not limited to the examples described above but may vary within the scope of the claims.

1. A receiver in a mobile communication network, including:
a receiving unit to receive signals transmitted through at least two channels;
a channel estimator to form a channel estimate for each transmit channel;
at least two linear filters, wherein each linear filter is configured to filter each transmitted signal received, each filter having a filter coefficient defining the filtering;
a calculating unit to form at least one combining weight by convolving each channel estimate and each filter coefficient; and
a combiner, which is configured to
form at least two filter-specific weighted signals by weighting each filtered signal with the at least one combining weight, and
combine the at least two filter-specific weighted signals to provide an estimate for the transmitted signals.

2. A receiver as claimed in claim 1, wherein the at least two linear filters include a first linear filter having a first filter coefficient and a second linear filter having a second filter coefficient, wherein the first filter is configured to receive a first channel having a first channel coefficient and the second filter is configured to receive a second channel having a second channel coefficient.

3. A receiver as claimed in claim 2, wherein
the calculating unit is configured to form a first combining weight by convolving the first filter coefficient and the first channel coefficient, and
the combiner is configured to form a filter-specific weighted signal for the first filter by applying the formed first combining weight.

4. A receiver as claimed in claim 2, wherein
the calculating unit is configured to form a second combining weight by convolving the first filter coefficient and the second channel coefficient, and
the combiner is configured to form a filter-specific weighted signal for the first filter by applying the formed second combining weight.

5. A receiver as claimed in claim 1, wherein the calculating unit is configured to form a space-time block decoding matrix of the at least one combining weight.

6. A receiver as claimed in claim 5, wherein the decoding matrix includes at least one matrix element different from a set of values including 0, 1 and −1.

7. A receiver as claimed in claim 1, wherein the combiner is configured to perform the combination according to following:
$${\hat{d}}_{1} \hat{=} [ \begin{matrix}{\hat{d}}_{1 , 1} \\ {\hat{d}}_{1 , 2}^{*}\end{matrix} ] = [ \begin{matrix}{h}_{1 , 1}^{*} & {h}_{2 , 1} \\ - {h}_{2.1}^{*} & {h}_{1 , 1}\end{matrix} ] \cdot {r}_{1}$$
$${\hat{d}}_{2} \hat{=} [ \begin{matrix}{\hat{d}}_{2 , 1} \\ {\hat{d}}_{2 , 2}^{*}\end{matrix} ] = [ \begin{matrix}{h}_{1 , 2}^{*} & {h}_{2 , 2} \\ - {h}_{22}^{*} & {h}_{1 , 2}\end{matrix} ] \cdot {r}_{2}$$
$$\hat{d} \hat{=} [ \begin{matrix}{\hat{d}}_{1} \\ {\hat{d}}_{2}^{*}\end{matrix} ] = {\hat{d}}_{1} + {\hat{d}}_{2}$$
, wherein
\hat{d} is an estimate for each transmitted signal d,
\hat{d}ⱼ estimate of the transmitted signal from each filter j=1,2,
\hat{d}_{j,n} an estimate of the transmitted signal from each filter j=1,2 at a time instant n=1,2,
h_{i,j} is a convolution of a channel coefficient of each channel i=1,2 and the filter coefficient of each filter j=1,2,
* denotes a complex conjugate, and
rᵢ is a signal received through each channel i=1,2.

8. A receiver as claimed in claim 1, wherein the combiner includes a closed-loop combiner for combining one symbol transmitted via the at least two channels.

9. A receiver as claimed in claim 8, wherein the closed-loop combiner is configured to perform combining each transmitted signal d being equal to w_{FBI,1}d+w_{FBI,2}d, wherein w_{FBI,1}d denotes a signal transmitted in a first channel and w_{FBI,2}d denotes a signal transmitted in a second channel, wherein w_{FBI,1} is a first weight factor and w_{FBI,2} is a second weight factor, the combining being performed according to formula:
$$\hat{d} \hat{=} [ {\hat{w}}_{FBI , 1}^{*} {h}_{1 , 1}^{*} + {\hat{w}}_{FBI , 2}^{*} {h}_{2 , 1}^{*} {\hat{w}}_{FBI , 1}^{*} {h}_{1 , 2}^{*} + {\hat{w}}_{FBI , 2}^{*} {h}_{2 , 2}^{*} ] [ \begin{matrix}{r}_{1} \\ {r}_{2}\end{matrix} ] ,$$
wherein
\hat{d} is an estimate for each transmitted signal d,
ŵ_{FBI,i}* is a complex-conjugate of assumed or estimated weight used in each channel i=1,2,
h_{i,j}* is a complex conjugate of a convolution for a channel coefficient of each channel i=1,2 and the filter coefficient of each filter j=1,2, and
rᵢ is a signal received through each channel i=1,2.

10. A receiver as claimed in claim 1, wherein the receiver includes a mobile phone.

11. A receiver in a mobile communication network, comprising:
means for receiving signals transmitted through at least two channels;
means for forming a channel estimate for each transmit channel;
means for filtering the received signals in channel-specific linear filters to provide an estimate for a desired signal in each channel;
means for forming at least one combining weight by convolving a channel estimate and a filter coefficient;
means for forming filter-specific weighted signals by weighting the received signals with the formed at least one combining weight;
means for combining the filter-specific weighted signals to provide an estimate for the transmitted signals.

12. A subassembly for a mobile terminal, comprising:
a calculating unit to form at least one combining weight by convolving a channel estimate and a filter coefficient; and
a combiner, which is configured to
form at least two filter-specific weighted signals by weighting a filtered signal with the at least one combining weight, and
combine the at least two filter-specific weighted signals.

13. A mobile communication system, comprising:
a transmitter and a receiver, wherein
the transmitter is configured to apply transmit diversity so as to provide at least two transmit channels, and the receiver is configured to
receive signals transmitted in the at least two transmit channels,
form a channel estimate for each transmit channel,
filter the received signals in channel-specific linear filters to provide an estimate for a desired signal in each transmit channel,
form at least one combining weight by convolving a channel estimate and a filter coefficient,
form filter-specific weighted signals by weighting the received signals with the formed at least one combining weight, and
combine the filter-specific weighted signals to provide an estimate for the transmitted signals.

14. A software product, including software code portions for implementing the steps of:
receiving signals transmitted in at least two transmit channels by applying transmit diversity;
forming a channel estimate for each transmit channel;
filtering the received signals in channel-specific linear filters to provide an estimate for a desired signal in each channel;
forming at least one combining weight by convolving a channel estimate and a filter coefficient;
forming filter-specific weighted signals by weighting the filtered signals with the formed at least one combining weight; and
combining the filter-specific weighted signals to provide an estimate for the transmitted signals.

15. A method for processing a signal in a mobile communication network, comprising:
transmitting signals via at least two transmit channels;
receiving the signals transmitted in the at least two transmit channels;
forming a channel estimate for each transmit channel;
filtering the received signals in channel-specific linear filters to provide an estimate for a desired signal in each channel;
forming at least one combining weight by convolving a channel estimate and a filter coefficient;
forming filter-specific weighted signals by weighting the filtered signals with the formed at least one combining weight; and
combining the filter-specific weighted signals to provide an estimate for the transmitted signals.
